(19) United States
(12) Patent Application Publication
(10) Pub. No.: US 2020/0023647 A1
(43) Pub. Date: Jan. 23, 2020

(54) LIQUID EJECTING HEAD, LIQUID EJECTING APPARATUS, AND METHOD FOR CONTROLLING THE SAME

(71) Applicant: SEIKO EPSON CORPORATION, Tokyo (JP)

(72) Inventors: Atsuhiro HASHIMOTO, Shiojiri-shi (JP); Masako FUKUDA, Shiojiri-shi (JP)

(21) Appl. No.: 16/515,812

(22) Filed: Jul. 18, 2019

(30) Foreign Application Priority Data
Jul. 18, 2018 (JP) 2018-134762

(51) Int. Cl. B41J 2/175; B41J 2/14

(52) U.S. Cl. CPC B41J 2/17596; B41J 2002/14419; B41J 2/14233

(57) ABSTRACT

A liquid ejecting head includes a nozzle from which liquid is ejected, a pressure compartment that is in communication with the nozzle, a flow passage configured to lead the liquid between the nozzle and pressure compartment, and an air discharge mechanism configured to discharge air to outside from inside of the flow passage.

The present application is based on, and claims priority from JP Application Serial Number 2018-134762, filed Jul. 18, 2018, the disclosure of which is hereby incorporated by reference herein in its entirety.

### BACKGROUND

### 1. Technical Field

Embodiments of the present disclosure relate to a liquid ejecting head such as an ink-jet recording head, a liquid ejecting apparatus equipped therewith, a method for controlling a liquid ejecting head, and a method for controlling a liquid ejecting apparatus. More particularly, the embodiments relate to a liquid ejecting head that has a flow passage leading from a pressure compartment to a nozzle, a liquid ejecting apparatus, and a method for controlling the same.

### 2. Related Art

A liquid ejecting apparatus is a device equipped with a liquid ejecting head and configured to eject (discharge) various kinds of liquid from the head. An image recording apparatus such as an ink-jet printer or an ink-jet plotter is known as an example of a liquid ejecting apparatus. To take advantage of their capability of ejecting a very small amount of liquid to a predetermined position accurately, liquid ejecting apparatuses have recently been applied to various manufacturing apparatuses. Some examples of the applications are: a display manufacturing apparatus for manufacturing a color filter for a liquid crystal display, etc.; an electrode forming apparatus for forming electrodes of an organic EL (electroluminescence) display or an FED (surface emission display), etc.; and a chip manufacturing apparatus for producing biochips (biochemical element). A recording head used for image recording ejects ink in the form of ink droplets. A color material ejecting head used for manufacturing display devices ejects a solution of R (red), G (green), and B (blue) colorants. An electrode material ejecting head used for forming electrodes ejects a liquid electrode material. A living organic material ejecting head used for chip production ejects a solution of a living organic material.

Among such a variety of liquid ejecting heads, some include a nozzle from which liquid is ejected, a pressure compartment that is in communication with the nozzle, and a drive element such as a piezoelectric element that causes pressure fluctuation in the liquid that is present inside the pressure compartment (in other words, a pressure generator). Liquid that is present inside a liquid flow passage sometimes contains an air bubble. If this happens when a liquid ejecting head such as one described above ejects the liquid, pressure that is necessary for ejecting the liquid will be absorbed by the air bubble. This might result in a failure to eject the liquid or defective ejection. For example, the liquid might not be ejected from the nozzle at all, or even if ejected, the actual amount of liquid ejection might be significantly smaller than the amount of liquid supposed to be ejected. To avoid a failure or defective ejection, a liquid ejecting apparatus equipped with such a liquid ejecting head is configured to supply liquid into a liquid flow passage of the liquid ejecting head after filtering the liquid as disclosed in, for example, JP-A-2004-174833. Because of this structure, an air bubble that is comparatively large in size is trapped by the filter. The trapped air bubble is removed by, for example, performing cleaning operation to forcibly let it out from the nozzle by suction.

By making the mesh of the filter finer, it is possible to catch a smaller air bubble. However, if the mesh of the filter is made finer, pressure loss increases. Therefore, there is a limit to making the mesh of the filter finer. For this reason, it is difficult to perfectly block the entry of an air bubble into a liquid ejecting head by means of a filter. Air that forms a bubble sometimes enters liquid inside a liquid flow passage via a nozzle when, for example, a medium such as a sheet of recording paper comes into contact with a surface in which nozzles of a liquid ejecting head are formed (hereinafter referred to as “nozzle surface”). In related art, it is difficult to perform normal liquid ejection from a nozzle if an air bubble stays in the neighborhood of the nozzle.

### SUMMARY

An advantage of some aspects of the present disclosure is to provide a liquid ejecting head, a liquid ejecting apparatus, a method for controlling a liquid ejecting head, and a method for controlling a liquid ejecting apparatus that makes it possible to discharge an air bubble from a flow passage leading from a pressure compartment to a nozzle.

A liquid ejecting head according to a certain aspect of the present disclosure includes a nozzle from which liquid is ejected, a pressure compartment that is in communication with the nozzle, and an air discharge mechanism that discharges air to outside of a flow passage from the flow passage leading from the pressure compartment to the nozzle.

The liquid ejecting head according to the above aspect is capable of discharging air such as an air bubble present inside the flow passage leading from the pressure compartment to the nozzle, using the air discharge mechanism. Therefore, it is possible to eliminate or reduce the influence of the air inside the flow passage on liquid ejection. Moreover, a reduction in liquid consumption is achieved because it is possible to discharge air present inside the flow passage without performing maintenance operation (i.e., cleaning operation) to forcibly let an air bubble out together with liquid from each nozzle of the liquid ejecting head.

In the above structure, the pressure compartment may be located above the nozzle in a vertical direction, and the air discharge mechanism may be provided closer to the pressure compartment than the nozzle in the vertical direction.

With this structure, since the air discharge mechanism provided closer to the pressure compartment than the nozzle is located near where air, that is, an air bubble, goes up due to buoyancy, it is easier to discharge the air bubble.

In the above structure, the air discharge mechanism may include a discharge passage, through which the air is discharged from the flow passage, and a partitioning member serving as a partition between the flow passage and the discharge passage.

The liquid ejecting head may further include a pressure reduction mechanism that reduces pressure inside the discharge passage.

With this structure, it is possible to discharge air present inside the flow passage toward the discharge passage more actively by reducing the pressure of the discharge passage.

In the above structure, the partitioning member may be a gas permeable member that is more permeable to the air than to the liquid.

This makes it possible to remove air present inside the flow passage by means of a simpler structure.

In the above structure, the partitioning member may be an on-off valve for switching between a communication state, in which the flow passage is in communication with the discharge passage, and a non-communication state, in which the flow passage is not in communication with the discharge passage.

With this structure, it is possible to discharge air present inside the flow passage toward the discharge passage more smoothly by operating the on-off valve.

The liquid ejecting head may further include an auxiliary on-off valve provided closer to the nozzle than the air discharge mechanism in the vertical direction and configured to switch between an open state of allowing the liquid to pass in the flow passage and a closed state of not allowing the liquid to pass in the flow passage.

By closing the auxiliary on-off valve when the on-off valve is open, this structure prevents external air from being sucked into the flow passage through the nozzle. Therefore, it is possible to apply greater negative pressure to the discharge passage, thereby more effectively discharging an air bubble present inside the flow passage.

A liquid ejecting apparatus according to a certain aspect of the present disclosure includes a liquid ejecting head having any of the above structure.

A method for controlling a liquid ejecting head according to a certain aspect of the present disclosure includes, for controlling the above liquid ejecting head, a first valve switching process of switching the auxiliary on-off valve from the open state to the closed state; a second valve switching process of switching the on-off valve from the non-communication state to the communication state in accordance with the first valve switching process; an air discharge process of discharging the air from the flow passage toward the discharge passage; a third valve switching process of switching the on-off valve from the communication state to the non-communication state after the air discharge process; and a fourth valve switching process of switching the auxiliary on-off valve from the closed state to the open state in accordance with the third valve switching process.

By closing the auxiliary on-off valve when the on-off valve is open, this control method makes it possible to discharge an air bubble present inside the flow passage while preventing external air from being sucked into the flow passage through the nozzle.

To a method for controlling a liquid ejecting apparatus according to a certain aspect of the present disclosure, the above method for controlling the liquid ejecting head is applied.

### BRIEF DESCRIPTION OF THE DRAWINGS

FIG. 1 is a front view illustrating an exemplary structure of a liquid ejecting apparatus.

FIG. 2 is a cross-sectional view illustrating the structure of a liquid ejecting head according to a first embodiment.

FIG. 3 is a cross-sectional enlarged view of a part of the liquid ejecting head.

FIG. 4 is a cross-sectional enlarged view of a part of the liquid ejecting head.

FIG. 5 is a block diagram that illustrates the electric configuration of the liquid ejecting apparatus.

FIG. 6 is a flowchart for explaining operation of the liquid ejecting head.

FIG. 7 is a cross-sectional view illustrating a variation example of the structure of a liquid ejecting head according to the first embodiment.

FIG. 8 is a cross-sectional view illustrating the structure of a liquid ejecting head according to a second embodiment.

FIG. 9 is a cross-sectional view illustrating the structure of a liquid ejecting head according to the second embodiment.

FIG. 10 is a flowchart for explaining a method for controlling a liquid ejecting head and a method for controlling a liquid ejecting apparatus according to the second embodiment.

FIG. 11 is a cross-sectional view illustrating the structure of a liquid ejecting head according to a third embodiment.

FIG. 12 is a cross-sectional view illustrating a variation example of the structure of a liquid ejecting head according to the third embodiment.

### DESCRIPTION OF EXEMPLARY EMBODIMENTS

With reference to the accompanying drawings, some exemplary embodiments of the present disclosure will now be explained in detail. Various specific features will be explained in the following embodiments of the disclosure for the purpose of disclosing some preferred examples thereof. They shall not however be construed to restrict the scope of the disclosure unless any intention of restriction is explicitly shown. In the following description, an ink-jet recording apparatus (hereinafter referred to as “printer”) 1 equipped with an ink-jet recording head (hereinafter referred to as “recording head”) 8, which is a kind of liquid ejecting head, is taken as an example of a liquid ejecting apparatus according to the present disclosure.

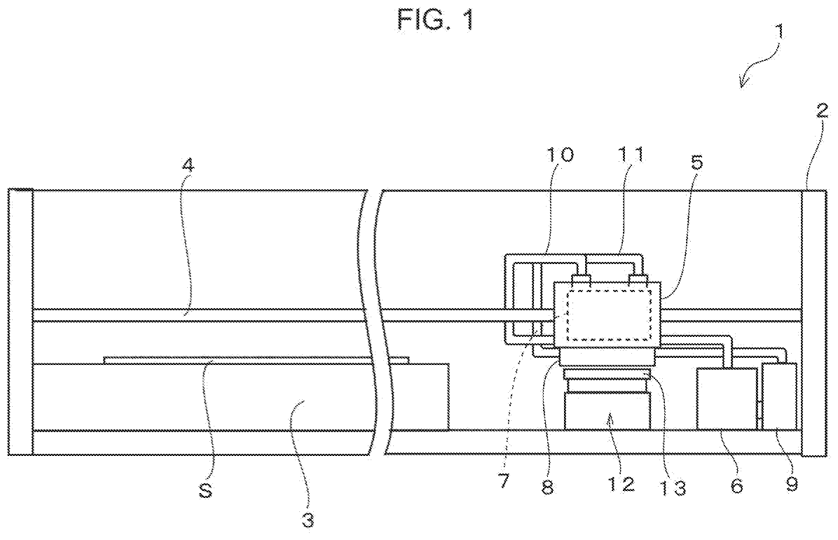

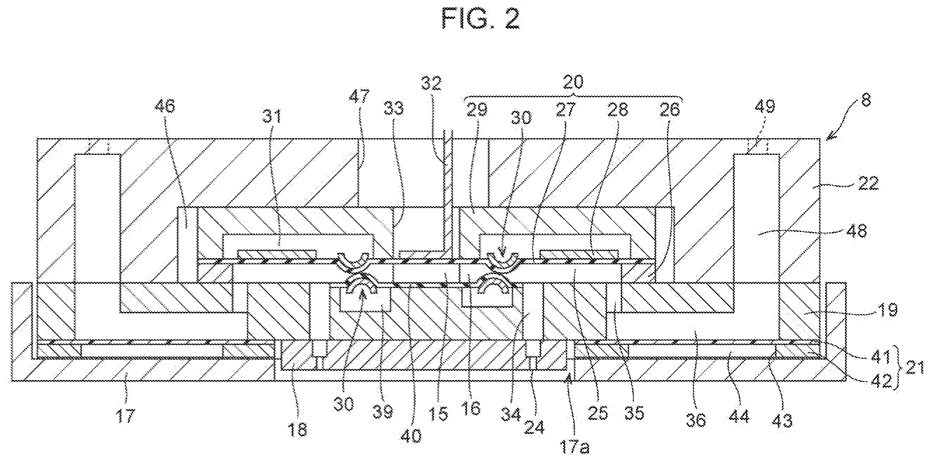

FIG. 1 is a front view showing an example of the structure of a printer 1. The printer 1 according to the first embodiment is an apparatus that records an image or a text, etc. by ejecting ink droplets (a kind of liquid according to the present disclosure) from a recording head 8 onto the surface of a print medium S such as a sheet of paper, a cloth, or a resin film, etc. The printer 1 includes a frame 2 and a platen 3. The platen 3 is provided inside the frame 2. A transportation mechanism that is not illustrated transports the print medium S onto the platen 3. A guiding rod 4 is provided in parallel with the platen 3 inside the frame 2. The recording head 8 and a carriage 5 housing a sub tank 7 are supported by the guiding rod 4 such that sliding movement is allowed. The sub tank 7 serves as an intermediary through which ink is transferred from an ink tank 6 to the recording head 8. The carriage 5 is configured to reciprocate along the guiding rod 4 in a main scan direction, which is orthogonal to a direction in which the print medium S is transported. The printer 1 of the present embodiment performs printing (in other words, recording) by ejecting ink from nozzles 24 of the recording head 8 (see FIG. 2, etc.) while reciprocating the carriage 5 in relation to the print medium S.

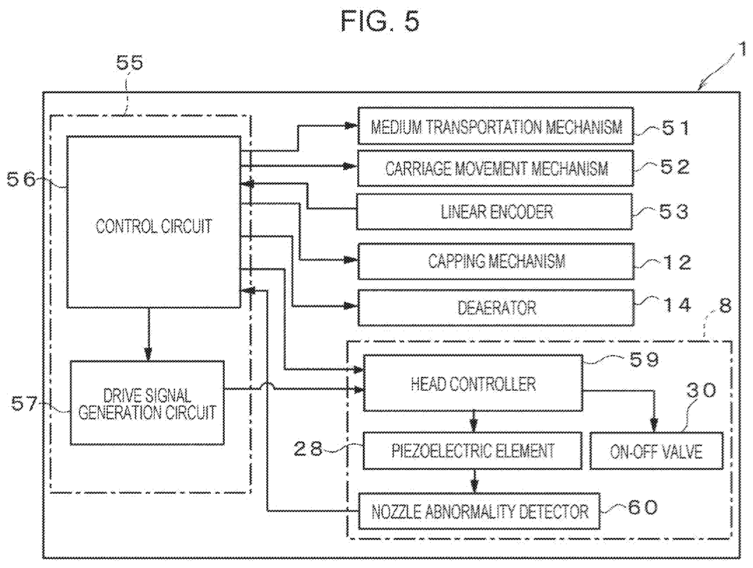

The ink tank 6, which is a kind of liquid container, is mounted on one side in the frame 2. Ink contained in the ink tank 6 is fed into the sub tank 7 through a supply tube 10 due to pressure applied by a pump 9 and is thereafter supplied to the recording head 8. The pump 9 is configured to reduce the internal pressure of a common discharge passage 15, which will be described later, inside the recording head 8 through a discharge tube 11. Due to the pressure reduction by the pump 9, ink that has flowed into the common discharge passage 15 via an individual discharge passage 16 from an individual flow passage (corresponding to a flow passage according to the present disclosure), which leads from a pressure compartment 25 to a nozzle 24 through a nozzle communication hole 34, is returned to the ink tank 6 via a deaerator 14 (see FIG. 5), which will be described later. Therefore, the pump 9 behaves as a kind of pressure reduction mechanism according to the present disclosure. The carriage 5 has a flow passage for supplying, to the recording head 8 via the sub tank 7, ink coming in through the supply tube 10, and a flow passage for sending out, to the discharge tube 11, ink and an air bubble discharged from the recording head 8, though they are not illustrated. In addition to an adjuster that adjusts supply pressure for supplying ink to the recording head 8, a filter or the like (not illustrated) for trapping an air bubble and a foreign object that are contained in ink is provided inside the sub tank 7. Although ink discharged from the common discharge passage 15 is returned to the ink tank 6 in the structure of the present embodiment described above, the scope of the disclosure is not limited to such an example. For example, ink discharged with an air bubble from the common discharge passage 15 may be drained through the discharge tube 11 to a waste ink tank that is not illustrated.

A capping mechanism 12 that includes a cap 13 for hermetically enclosing the nozzle surface of the recording head 8 is provided at a home position on one side in the movement range of the recording head 8 inside the frame 2. The cap 13 of the capping mechanism 12 hermetically encloses the nozzle surface of the recording head 8 that is in a standby state at the home position, thereby preventing the solvent of ink from vaporizing through the nozzles 24. In addition, the capping mechanism 12 can be used also for cleaning operation, in which ink and air bubbles are forcibly sucked out through the nozzles 24 by making pressure inside the closed space negative due to suction after hermetically enclosing the nozzle surface of the recording head 8.

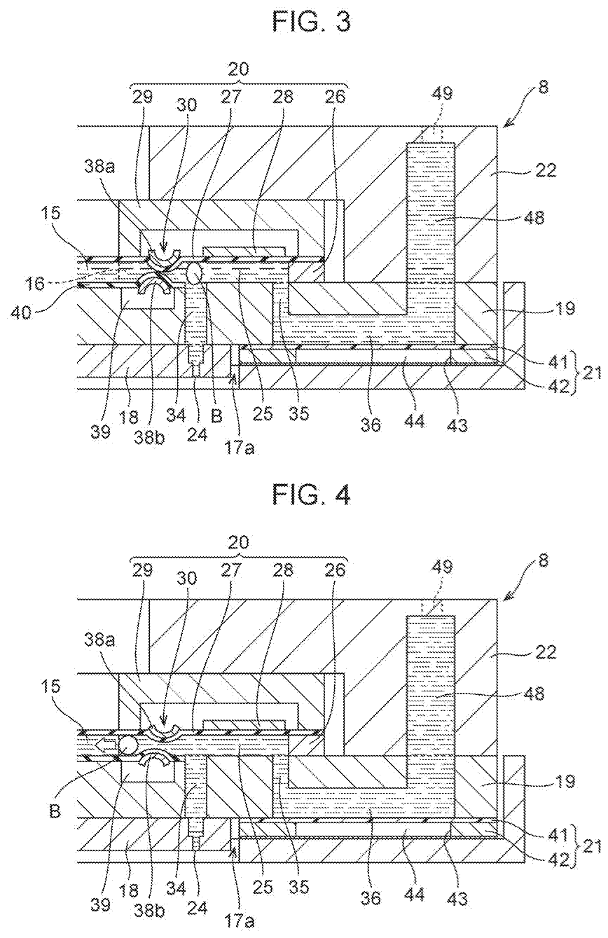

Next, the structure of the recording head 8 will now be explained. FIG. 2 is a cross-sectional view of the recording head 8. FIG. 3, 4 is a cross-sectional enlarged view of a part of the recording head 8 illustrated in FIG. 2. In FIG. 3, a partial structure with a closed state of an on-off (open/close) valve 30 is illustrated. In FIG. 4, a partial structure with an open state of the on-off valve 30 is illustrated. In FIG. 2, a state in which an ink flow passage including the pressure compartment 25, etc. is not filled with ink is illustrated. In FIG. 3, 4, a state in which the ink flow passage is filled with ink is illustrated.

To constitute the recording head 8 of the present embodiment, a plurality of constituent members such as a fixing plate 17, a nozzle plate 18, a communication plate 19, an actuator unit 20, a compliance substrate 21, and a holder 22, etc. are stacked and bonded together by means of an adhesive, etc. In the description below, the direction in which the constituent members of the recording head 8 are stacked is referred to as “vertical direction”, where appropriate. It is theoretically assumed here that the vertical direction is the same as the direction of perpendicularity. However, it should be noted that, in actual implementation, the vertical direction might not be exactly the same as the direction of perpendicularity.

The actuator unit 20 has a unit structure formed by stacking a pressure compartment substrate 26, a first diaphragm 27, a piezoelectric element 28, and a protection substrate 29 in this order. In addition to them, the actuator unit 20 of the present embodiment includes an on-off valve 30. The on-off valve 30 and a neighborhood structure near this valve will be described in detail later. The pressure compartment substrate 26 of the present embodiment is made of a silicon single crystal substrate. The pressure compartment substrate 26 has an array of spaces formed as the pressure compartments 25 corresponding to the plurality of nozzles 24. The pressure compartment 25 is a space that is elongated in a direction intersecting with a row of nozzles. A nozzle communication hole 34 of the communication plate 19 is formed in communication with one end in the longitudinal direction of the pressure compartment 25. An individual communication hole 35 of the communication plate 19 is formed in communication with the other end in the longitudinal direction of the pressure compartment 25. Two rows of the pressure compartments 25 are formed in the pressure compartment substrate 26 of the present embodiment. If the side at which the first diaphragm 27 is provided over the pressure compartment substrate 26 in the stack structure is defined as the top side, and further if the side at which the communication plate 19 is provided under the pressure compartment substrate 26 in the stack structure is defined as the bottom side, the surface of the first diaphragm 27 defines the ceiling (top) of the pressure compartment 25, and the surface of the communication plate 19 defines the floor (bottom) of the pressure compartment 25. The nozzle communication hole 34 is in communication with the floor of the pressure compartment 25.

The common discharge passage 15 mentioned above is formed between the rows of the pressure compartments 25, that is, at the center area of the pressure compartment substrate 26. The common discharge passage 15 is a space that is common to the pressure compartments 25. Specifically, the common discharge passage 15 is formed as a continuous stretch of cavity extending in the array direction of the pressure compartments 25, that is, along each row of nozzles. Each individual discharge passage 16 is a flow passage for individual communication from the corresponding pressure compartment 25 to the common discharge passage 15. In the present embodiment, the on-off valve 30, the individual discharge passage 16, and the common discharge passage 15 behave as an example of an air discharge mechanism according to the present disclosure. Among them, the individual discharge passage 16 and the common discharge passage 15 correspond to an example of a discharge passage according to the present disclosure. The on-off valve 30 switches the state of communication between an individual flow passage, which leads from the pressure compartment 25 to the nozzle 24 through the nozzle communication hole 34, and a discharge passage (i.e., the individual discharge passage 16 and the common discharge passage 15) from “in communication (communication state)” to “not in communication (non-communication state)”, and vice versa. The on-off valve 30 is a kind of partitioning member serving as a partition between the individual flow passage and the discharge passage (i.e., the individual discharge passage 16 and the common discharge passage 15).

In the present embodiment, the pressure compartment 25 is located above the nozzle 24 in the vertical direction, and the air discharge mechanism is provided closer to the pressure compartment 25 than the nozzle 24 in the vertical direction. Specifically, the position where the air discharge mechanism is provided is as close as possible to the ceiling of the pressure compartment 25, or in other words, as close as possible to the uppermost one in the vertical direction among the surfaces surrounding the pressure compartment 25. More specifically, in the present embodiment, the ceiling of the individual discharge passage 16 and the ceiling of the common discharge passage 15 are level with the ceiling of the pressure compartment 25 corresponding to the individual discharge passage 16. Because of this structure, the air discharge mechanism provided closer to the pressure compartment 25 than the nozzle 24 is located near where air, that is, an air bubble, goes up due to buoyancy. In air bubble discharging operation that will be described later, this makes it easier to discharge an air bubble staying near the ceiling of the pressure compartment 25 in the individual flow passage toward the common discharge passage 15. In light of the above advantage, it is desirable to provide the air discharge mechanism closer to the pressure compartment 25 than the nozzle 24 in the vertical direction above the floor of the pressure compartment 25, that is, closer to the ceiling thereof. This structure makes it possible to effectively discharge an air bubble staying near the ceiling of the pressure compartment 25 due to buoyancy.

The first diaphragm 27 is provided on the upper surface of the pressure compartment substrate 26, the opposite surface of which is on the communication plate 19. The opening at the top of the pressure compartments 25, the individual discharge passages 16, and the common discharge passage 15 is hermetically closed by the first diaphragm 27. The first diaphragm 27 is made up of, for example, an elastic film that is made of silicon dioxide (SiO₂) and is formed over the upper surface of the pressure compartment substrate 26, and an insulation film that is made of zirconium oxide (ZrO₂) and is formed on the elastic film. A piezoelectric element 28 is formed as an example of a drive element on the first diaphragm 27 at an area corresponding to the top opening of each of the pressure compartments 25. The piezoelectric element 28 of the present embodiment is a so-called flexural-mode piezoelectric element. The piezoelectric element 28 has a layered structure produced by sequentially forming, for example, a lower electrode layer, a piezoelectric layer, and an upper electrode layer (none of which is illustrated) on the first diaphragm 27. Flexural deformation of the piezoelectric element 28 having such a structure occurs in the vertical direction when an electric field corresponding to a potential difference between the electrode of the lower electrode layer and the electrode of the upper electrode layer is applied therebetween. In the present embodiment, two rows of the piezoelectric elements 28 corresponding to the two rows of the pressure compartments 25 are formed.

An upper on-off valve piezoelectric element 38a, which is one of a pair of on-off valve piezoelectric elements 38a and 38b constituting the on-off valve 30, is provided on the first diaphragm 27 at a position corresponding to the individual discharge passage 16. The upper on-off valve piezoelectric element 38a is a flexural-mode piezoelectric element that has a layered structure produced by sequentially forming a lower electrode layer, a piezoelectric layer, and an upper electrode layer (none of which is illustrated) on the first diaphragm 27, similarly to the piezoelectric element 28.

The protection substrate 29 is provided over the first diaphragm 27 such that the rows of the piezoelectric elements 28 are enclosed. For insertion of a wiring board 32, the protection substrate 26 has a wiring space 33 at its center. Lead electrodes of the piezoelectric elements 28 and lead electrodes of the on-off valve piezoelectric elements 38a and 38b, which constitute the on-off valve 30, are arranged inside the wiring space 33. Wiring terminals of the wiring board 32 are electrically connected to these lead electrodes. The piezoelectric element 28 is driven for ink ejection control when a drive signal sent from the control unit of the printer 1 is applied to the piezoelectric element 28 via the wiring board 32. Similarly, the opening/closing of the on-off valve 30 is controlled by applying a valve-opening/closing drive signal to the on-off valve piezoelectric elements 38a and 38b. An accommodation space 31 for housing the piezoelectric elements 28 and the upper on-off valve piezoelectric elements 38a is formed inside the protection substrate 29. The accommodation space 31 is a cavity formed from the lower surface of the protection substrate 29, or in other words, from its bottom over the first diaphragm 27, toward the upper surface of the protection substrate 29, or in other words, toward the holder 22, halfway in the height direction of the protection substrate 29. The protection substrate 29 of the present embodiment has the accommodation spaces 31 on respective two sides next to the wiring space 33. The communication plate 19, which has a wider area than the actuator unit 20, is bonded to the lower surface of the actuator unit 20.

The communication plate 19 is made of a silicon single crystal substrate, similarly to the pressure compartment substrate 26. The nozzle communication holes 34, which are for communication between the pressure compartments 25 and the nozzles 24, a reservoir 36, which is shared by the pressure compartments 25, and the individual communication holes 35, which are for individual communication from the reservoir 36 to the pressure compartments 25, are formed in the communication plate 19 of the present embodiment by, for example, anisotropic etching. An accommodation recess 39 for housing the lower on-off valve piezoelectric element 38b, which is the other of the pair of on-off valve piezoelectric elements 38a and 38b constituting the on-off valve 30, is formed in the communication plate 19 of the present embodiment by anisotropic etching, similarly to the nozzle communication hole 34, etc.

The reservoir 36 is a liquid chamber that extends in the nozzle-row direction. In the communication plate 19 of the present embodiment, two reservoirs corresponding respectively to the two nozzle rows of the nozzle plate 18 are formed. The opening at the bottom of the reservoir 36 is hermetically closed by a compliance sheet 41 of the compliance substrate 21. Alternatively, a plurality of reservoirs may be provided for each one nozzle row, and different kinds of ink may be assigned to the plurality of reservoirs respectively. The reservoir 36 is formed by anisotropic etching applied from the lower surface of the communication plate 19. Ink coming in through an inlet 49 of an incoming liquid chamber 48 formed in the holder 22 flows into the reservoir 36 as will be described later. The plurality of individual communication holes 35 is formed in array in the nozzle-row direction correspondingly to the respective pressure compartments 25. The individual communication hole 35 is formed in communication with the other end in the longitudinal direction of the pressure compartment 25 (that is, the opposite of the end that is in communication with the nozzle communication hole 34). The nozzle communication hole 34 is a flow passage formed as a through-hole opening in the thickness direction of the communication plate 19 for individual communication from the pressure compartment 25 to the nozzle 24. Namely, the ink in the reservoir 36 flows into each of the pressure compartments 25 through the corresponding individual communication hole 35 and is then supplied to the corresponding nozzle 24 through the corresponding nozzle communication hole 34. In the present embodiment, via the on-off valve 30 and the individual discharge passage 16, the common discharge passage 15 is in communication with the individual flow passage leading from the pressure compartment 25 to the nozzle 24 through the nozzle communication hole 34.

In the communication plate 19, the accommodation recesses 39 are formed at an area between the rows of the nozzle communication holes 34 corresponding respectively to the rows of nozzles. As mentioned above, the accommodation recess 39 is a space for housing the lower on-off valve piezoelectric element 38b and is formed by, for example, anisotropic etching applied from the upper surface of the communication plate 19 halfway in the thickness direction of the communication plate 19. The opening of the accommodation recess 39 is hermetically closed by a second diaphragm 40. The second diaphragm 40 is a flexible member that is deformable when the lower on-off valve piezoelectric element 38b is driven. The second diaphragm 40 is made up of, for example, an elastic film and an insulation film, similarly to the first diaphragm 27 mentioned above. The lower on-off valve piezoelectric element 38b is formed on the surface of the second diaphragm 40 toward the accommodation recess 39. The lower on-off valve piezoelectric element 38b is also a flexural-mode piezoelectric element that has a layered structure produced by sequentially forming a lower electrode layer, a piezoelectric layer, and an upper electrode layer, none of which is illustrated. The lead electrode of the lower on-off valve piezoelectric element 38b is routed into the wiring space 33 described above. The lower on-off valve piezoelectric element 38b becomes deformed when a valve-opening/closing drive signal is applied thereto via the wiring board 32.

The nozzle plate 18, in which the plurality of nozzles 24 is formed, is bonded to substantially the center area of the lower surface of the communication plate 19 described above. The nozzle plate 18 of the present embodiment is a plate member that is smaller in contour shape than the communication plate 19 and the actuator unit 20 and is made of, for example, a silicon single crystal substrate or a metal plate such as a stainless-steel plate. After the nozzle communication holes 34 are positioned to be in communication with the nozzles 24 respectively, the nozzle plate 18 is bonded to the lower surface of the communication plate 19 by means of an adhesive, etc. at an area where the openings of the nozzle communication holes 34 exist, without overlapping with the opening area of the reservoir 36. In the present embodiment, the nozzle plate 18 has two rows of the nozzles 24 (or in other words, nozzle groups) in total.

The compliance substrate 21 is bonded to the lower surface of the communication plate 19 without overlapping with the nozzle plate 18. The opening of the reservoir 36 in the lower surface of the communication plate 19 is hermetically closed by the compliance substrate 21 positioned and bonded to the lower surface of the communication plate 19. The compliance substrate 21 of the present embodiment includes the compliance sheet 41 and a supporting plate 42. The supporting plate 42 is bonded to, and supports, the compliance sheet 41. Since the compliance sheet 41 of the compliance substrate 21 is bonded to the lower surface of the communication plate 19, the compliance sheet 41 is sandwiched between the communication plate 19 and the supporting plate 42. The compliance sheet 41 is a flexible thin film made of a synthetic resin material, for example, polyphenylene sulfide (PPS) or the like. The supporting plate 42 is made of a metal material that has greater rigidity than that of the compliance sheet 41 and is thicker than the compliance sheet 41, for example, stainless steel or the like. At the area facing the reservoir 36, the supporting plate 42 has a compliance opening 43 formed by removing a part of the supporting plate 42 in a shape conforming to the shape of the opening at the bottom of the reservoir 36. Therefore, the opening at the bottom of the reservoir 36 is hermetically closed solely by the compliance sheet 41, which has flexibility. In other words, the compliance sheet 41 constitutes a part of the spatial boundary of the reservoir 36.

The portion corresponding to the compliance opening 43 in the bottom of the supporting plate 42 is hermetically closed by the fixing plate 17. Therefore, a compliance space 44 is formed between the flexible region of the compliance sheet 41 and the fixing plate 17 facing it. In accordance with pressure fluctuation inside the ink flow passage, especially inside the reservoir 36, the flexible region of the compliance sheet 41 over the compliance space 44 deforms and changes its position into the reservoir 36 or into the compliance space 44. Therefore, the thickness of the supporting plate 42 is designed in accordance with the required height of the compliance space 44.

In a plan view, the holder 22 has substantially the same shape as that of the communication plate 19. An accommodation space 46 for housing the actuator unit 20 is formed in the bottom of the holder 22. The lower surface of the holder 22 is hermetically fixed to the communication plate 19, with the actuator unit 20 housed inside the accommodation space 46. An insertion space 47, which is in communication with the accommodation space 46, is formed substantially at the center of the holder 22 in a plan view. The insertion space 47 is in communication with the wiring space 33 for the actuator unit 20, too. The aforementioned wiring board 32 is inserted into the wiring space 33 through the insertion space 47. The incoming liquid chambers 48, which are in communication with the reservoirs 36 of the communication plate 19, are formed inside the holder 22 on respective two sides, and the insertion space 47 and the accommodation space 46 are located therebetween. The inlets 49, which are in communication with the incoming liquid chambers 48 respectively, are formed in the top of the holder 22. The ink sent from the ink tank 6 enters the space of the incoming liquid chamber 48 through the inlet 49. That is, the ink sent from the ink tank 6 flows into the reservoir 36 through the inlet 49 and the incoming liquid chamber 48 and is then supplied from the reservoir 36 to each of the pressure compartments 25 through the corresponding individual communication hole 35.

The fixing plate 17 is a plate member that is made of metal, for example, stainless steel or the like. At a position corresponding to the nozzle plate 18, the fixing plate 17 of the present embodiment has a through hole 17a that is formed in the thickness direction along the contour of the nozzle plate 18 for the purpose of exposing the nozzles 24 formed in the nozzle plate 18. In the present embodiment, the lower surface of the fixing plate 17 and the exposed surface of the nozzle plate 18 through the through hole 17a constitute the nozzle surface. The fixing plate 17 is fixed to a non-illustrated holding member such as a case that holds the recording head 8.

In the recording head 8 having the above structure, the flow passage from the incoming liquid chamber 48 to the nozzle 24 through the reservoir 36, the individual communication hole 35, the pressure compartment 25, and the nozzle communication hole 34 is filled with ink, and, after that, the piezoelectric element 28 is driven in accordance with a drive signal applied from a driver IC 38. The driving of the piezoelectric element 28 in this ink-filled state causes pressure vibration in the ink inside the pressure compartment 25. Due to the pressure vibration, the ink is ejected from the ejection-commanded nozzle 24.

Next, the electric configuration of the printer 1 will now be explained. FIG. 5 is a block diagram that illustrates the electric configuration of the printer 1. The printer 1 of the present embodiment includes a medium transportation mechanism 51, a carriage movement mechanism 52, a linear encoder 53, the capping mechanism 12, the deaerator 14, the recording head 8, and a printer controller 55 for controlling them.

The printer controller 55 of the present embodiment includes a control circuit 56 and a drive signal generation circuit 57, etc. The control circuit 56 is an arithmetic processor for controlling the entire printer operation. The control circuit 56 includes a CPU and a memory, etc., which are not illustrated. The control circuit 56 controls each unit in the printer 1 in accordance with a program, etc. stored in the memory. In the present embodiment, based on print job data received from an external device, etc., the control circuit 56 generates ejection data for ejecting ink from the nozzles 24 of the recording head 8 and transmits the ejection data to a head controller 59 of the recording head 8 when printing is performed. In addition, the control circuit 56 generates a timing signal from an encoder signal, which is outputted from the linear encoder 53 in accordance with the movement (i.e., main scan) of the carriage 5. The drive signal generation circuit 57 outputs a drive signal each time the timing signal is received. Based on waveform data regarding a drive signal waveform, the drive signal generation circuit 57 generates an analog voltage signal and generates a drive signal by causing a non-illustrated amplification circuit to amplify the generated signal. The drive signal generated by the drive signal generation circuit 57 is transmitted to the head controller 59 of the recording head 8. In addition, the drive signal generation circuit 57 outputs a valve-opening/closing drive signal, which is for opening/closing the aforementioned on-off valve 30, to the head controller 59 of the recording head 8. The valve-opening/closing drive signal includes, for example, a valve-closing voltage having a certain level for keeping the on-off valve 30 closed and a pulsed valve-opening voltage for keeping the on-off valve 30 open for a predetermined length of time.

The carriage movement mechanism 52 includes a non-illustrated drive motor (for example, DC motor) that supplies movement drive power via a timing belt, etc. and causes the recording head 8 mounted on the carriage 5 to move in the main scan direction along the guiding rod 4. The medium transportation mechanism 51 performs sub scanning by feeding sheets of the print medium S one after another onto the platen 3. The linear encoder 53 outputs, to the control circuit 56 of the printer controller 55, an encoder signal corresponding to the scan position of the recording head 8 mounted on the carriage 5 as position information in the main scan direction. Based on the encoder signal received from the linear encoder 53, the control circuit 56 recognizes the scan position (i.e., current position) of the recording head 8.

The deaerator 14 is a mechanism for removal of an air bubble or dissolved air (hereinafter simply referred to as “air” where appropriate) that is present in ink discharged from the common discharge passage 15. Some examples of a method that can be used for deaeration are: a method of directly reducing the pressure of the internal space of a non-illustrated container that contains ink and a method of membrane deaeration, in which the pressure of the external space of a hollow fiber membrane is reduced while causing ink to flow through the hollow fiber membrane. Ink after deaeration by the deaerator 14 is returned to the ink tank 6.

The recording head 8 includes the head controller 59, the piezoelectric element 28, the on-off valve 30, and a nozzle abnormality detector 60. The nozzle abnormality detector 60 is a mechanism for detecting ejection abnormality (or in other words, a defect in ejection) for each nozzle 24 of the recording head 8. The nozzle abnormality detector 60 checks whether ink is ejected normally from the nozzle 24 or not during printing. The nozzle abnormality detector 60 of the present embodiment is configured to output, to the control circuit 56 as a detection signal, an electromotive signal of the piezoelectric element 28 based on vibrations that occur in ink inside the pressure compartment 25 when the piezoelectric element 28 is driven for ink ejection. Based on the detection signal outputted from the nozzle abnormality detector 60, the control circuit 56 determines whether ink is ejected from the nozzle 24 normally or not. The frequency and amplitude of the above-mentioned detection signal under an abnormal condition are different from normal frequency and normal amplitude that have been acquired in advance. For example, such a difference is detected when no ink is ejected from the nozzle 24 at all or when the amount of ink ejected from the nozzle 24 is significantly smaller than a normal amount or the speed of traveling in air (initial speed) is significantly lower than a normal speed, though ejected. The frequency and amplitude of the detection signal deviates significantly from normal frequency and normal amplitude especially when an air bubble B exists somewhere inside the individual flow passage leading from the pressure compartment 25 to the nozzle 24 (see FIG. 3). Ejection abnormality due to the presence of an air bubble can be detected using some known detection method, though a detailed explanation is not given here because a method for obtaining the detection signal such as the above-described detection of ejection abnormality based on the electromotive signal is well known. The method for detecting ejection abnormality is not limited to the above example of using the electromotive force of the piezoelectric element 28. There are various well-known methods, for example, optical detection of an ink droplet ejected from the nozzle 24.

In print operations, the printer 1 that has the above structure causes its medium transportation mechanism 51 to feed sheets of the print medium S one after another and ejects ink that is a kind of liquid from the nozzles 24 of the recording head 8 in the form of ink droplets onto the surface of the print medium S while moving the recording head 8 in the main scan direction in relation to the print medium S, thereby printing an image, etc. thereon.

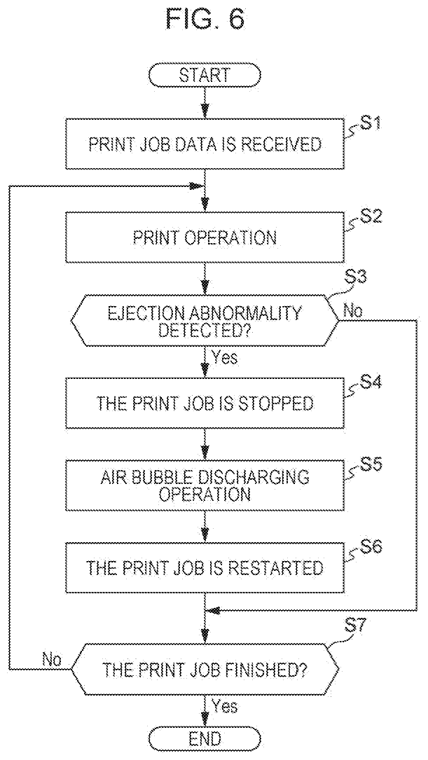

FIG. 6 is a flowchart that illustrates a flow of processing in printing by the printer 1 of the present embodiment. The following exemplary situation is described in the illustrated embodiment: ejection abnormality is detected by the nozzle abnormality detector 60 during the execution of a series of print operations based on a print job, and an air bubble is discharged from the individual flow passage leading from the pressure compartment 25 to the nozzle 24. When printing is performed, usually, a valve-closing voltage is applied continuously to each of the on-off valve piezoelectric elements 38a and 38b, which constitute the on-off valve 30. Therefore, the on-off valve piezoelectric elements 38a and 38b deform toward, and become in contact with, each other, to close the on-off valve 30. That is, the on-off valve 30 shuts off the common discharge passage 15 and the individual flow passage leading from the pressure compartment 25 to the nozzle 24 from each other, thereby producing a non-communication state such that the flow of ink from the individual flow passage to the common discharge passage 15 is blocked. When print job data is received from an external device, etc. (step S1), a print job for the print medium S, that is, printing, is started (step S2). During the execution of printing, the control circuit 56 monitors the nozzle abnormality detector 60 and determines based on the detection signal from the nozzle abnormality detector 60 whether ejection abnormality is detected or not (step S3). The process proceeds to a step S7 by skipping steps S4, S5, and S6 if ejection abnormality is not detected (determination: No).

If it is determined in the step S3 that ejection abnormality is detected (Yes), the print job that is currently being executed is stopped (step S4). Then, air bubble discharging operation is performed to discharge the air bubble B by the aforementioned air discharge mechanism from the individual flow passage corresponding to the abnormality-detected nozzle 24 (step S5). In the air bubble discharging operation, the pump 9, which is an example of the pressure reduction mechanism, is driven to reduce pressure inside the common discharge passage 15 to make it lower than the pressure of ink inside the individual flow passage, and, in addition, a valve-opening voltage (i.e., valve-opening pulse) is applied to each of the on-off valve piezoelectric elements 38a and 38b constituting the on-off valve 30 corresponding to the abnormality-detected nozzle 24. In the present embodiment, the valve-opening voltage is set to be lower than the valve-closing voltage. Accordingly, the on-off valve piezoelectric elements 38a and 38b, which were in contact with each other, change in shape flexibly to become separated from each other and open the valve for a duration of time corresponding to the width of the valve-opening pulse (or in other words, for a duration of valve-opening voltage application). That is, the individual flow passage leading from the pressure compartment 25 to the nozzle 24 and the common discharge passage 15 become in communication with each other via the individual discharge passage 16, thereby producing an in-communication state such that ink with an air bubble is allowed to flow from the individual flow passage to the common discharge passage 15. As illustrated in FIG. 4, the air bubble B is discharged together with a part of the ink in the individual flow passage to the common discharge passage 15 through the individual discharge passage 16 because of the reduced pressure of the common discharge passage 15. After the air bubble B is discharged to the common discharge passage 15, a valve-closing voltage is applied to each of the on-off valve piezoelectric elements 38a and 38b to close the on-off valve 30 and produce a non-communication state. In the present embodiment, the ink together with the air bubble B discharged to the common discharge passage 15 is sent to the deaerator 14 through the discharge tube 11 and is, after deaeration by the deaerator 14, returned to the ink tank 6 for reuse. After the on-off valve 30 is closed as described above, the print job that was stopped is restarted (step S6).

In a step S7, it is determined whether the print job for the print medium S has finished or not. If the print job for the print medium S has not finished yet (determination: No), the process returns to the step S2, and the printing continues. If it is determined in the step S7 that the print job for the print medium S has finished (Yes), the series of print operations ends. Although it is described in the present embodiment that air bubble discharging operation is performed at the timing of detection of ejection abnormality by the nozzle abnormality detector 60 during the execution of a series of print operations based on a print job, the scope of the disclosure is not limited to such an example. For example, air bubble discharging operation may be performed at the timing of receiving, from a user, an instruction for performing air bubble discharging operation via a printer driver, etc. run by an external device connected to the printer 1, at the timing of power on of the printer 1 before execution of printing, or after the execution of cleaning operation by the capping mechanism 12, and so forth.

Although it is described in the present embodiment that air bubble discharging operation is performed for the abnormality-detected nozzle 24 after stopping printing if ejection abnormality is detected by the nozzle abnormality detector 60, the scope of the disclosure is not limited to such an example. The apparatus may continue printing even if ejection abnormality is detected. In this case, air bubble discharging operation may be performed by canceling the driving of the piezoelectric element corresponding to the abnormality-detected nozzle 24 only immediately after detecting the ejection abnormality, or, alternatively, air bubble discharging operation may be performed for the abnormality-detected nozzle 24 when the earliest time of non-ejection of ink (that is, a non-recording period) has come for the abnormality-detected nozzle 24, based on the print job data. By this means, it is possible to remove the air bubble without affecting the execution time of the print job.

As explained above, the printer 1 according to the present disclosure is capable of discharging an air bubble, that is, air, present inside the individual flow passage leading from the pressure compartment 25 to the nozzle 24 through the nozzle communication hole 34 to the outside of the individual flow passage, that is, toward the common discharge passage 15, using the air discharge mechanism. Therefore, it is possible to eliminate or reduce the influence of the air bubble on ink ejection. Moreover, a reduction in ink consumption is achieved because it is possible to remove an air bubble present inside the individual flow passage without performing cleaning operation to forcibly let the air bubble out together with ink from each nozzle 24 of the recording head 8 using the capping mechanism 12. Furthermore, in the present embodiment, since the pressure of the individual discharge passage 16 and the common discharge passage 15 as an example of a discharge passage is reduced by the pump 9 as an example of a pressure reduction mechanism, it is possible to discharge air present inside the individual flow passage toward the discharge passage more actively. Furthermore, in the present embodiment, it is possible to discharge air present inside the individual flow passage toward the common discharge passage 15 more smoothly by operating the on-off valve 30.

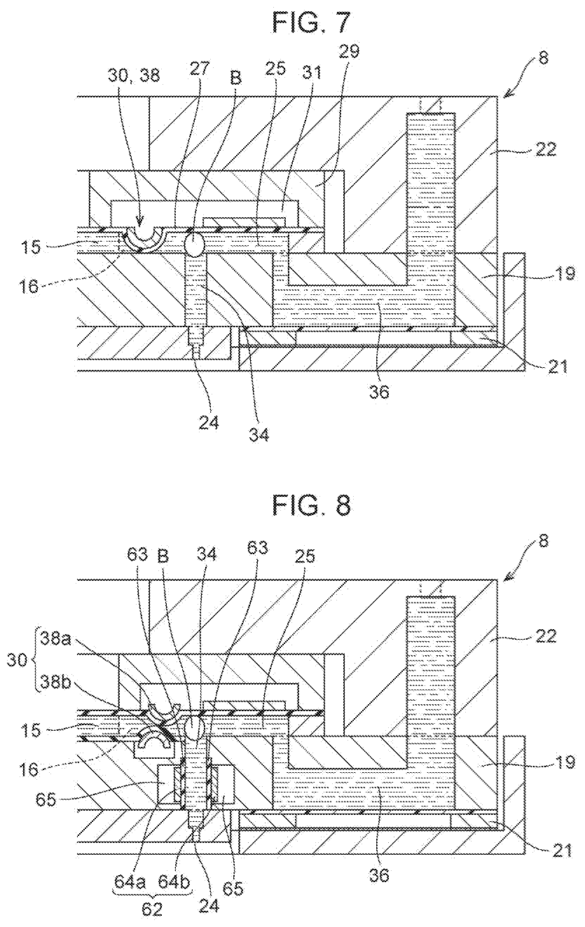

FIG. 7 is a cross-sectional view for explaining a variation example of the recording head 8 of the present embodiment. A partial structure with a closed state of an on-off valve 30 is illustrated therein. In the foregoing first embodiment, the on-off valve 30 is made up of a pair of the on-off valve piezoelectric elements 38a and 38b. However, the scope of the disclosure is not limited to such an example. In the variation example illustrated in FIG. 7, an on-off valve piezoelectric element 38 alone, which is provided on the first diaphragm 27, behaves as the on-off valve 30. In this structure, the on-off valve piezoelectric element 38 deforms toward the bottom of the individual discharge passage 16 (i.e., surface on the communication plate 19) to come into contact with the bottom of the individual discharge passage 16, thereby closing the individual discharge passage 16 and producing a valve-closed state such that the flow of ink from the individual flow passage to the common discharge passage 15 is blocked. The on-off valve piezoelectric element 38 changes in shape flexibly toward the accommodation space 31 of the protection substrate 29 to become separated from the bottom of the individual discharge passage 16, thereby opening the individual discharge passage 16 and producing a valve-open state such that ink is allowed to flow from the individual flow passage to the common discharge passage 15. Since a single piezoelectric element suffices as the constituent of the on-off valve 30, this structure is simpler and contributes to a reduction in size of the recording head 8. In the example illustrated in FIG. 7, the on-off valve piezoelectric element 38 is provided on the first diaphragm 27. However, for example, the on-off valve piezoelectric element 38 may be provided at a position corresponding to the lower on-off valve piezoelectric element 38b in the foregoing first embodiment (i.e., on the surface of the second diaphragm 40 toward the accommodation recess 39 in the foregoing first embodiment). Although the piezoelectric element(s) is used for the on-off valve 30 in the foregoing example, various well-known other structure can be used instead, as long as it is capable of opening and closing the flow passage. Except for the difference described above, the structure is the same as that of the first embodiment.

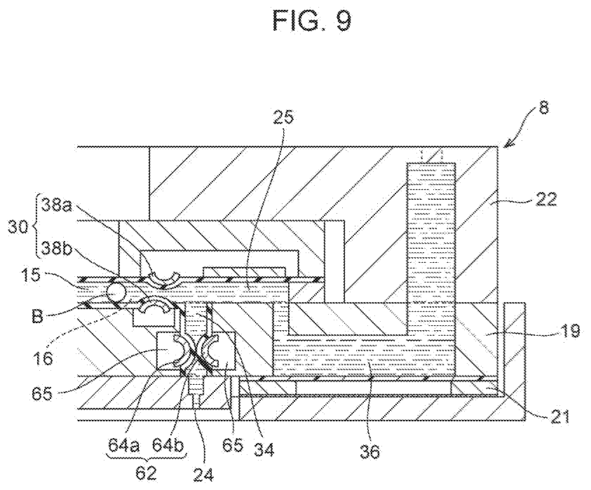

FIGS. 8 and 9 are cross-sectional enlarged views of a part of the recording head 8 according to a second embodiment of the present disclosure. In FIG. 8, the on-off valve 30 is closed, and an auxiliary on-off valve 62 is open. In FIG. 9, the on-off valve 30 is open, and the auxiliary on-off valve 62 is closed. The present embodiment is different from the foregoing first embodiment in that the auxiliary on-off valve 62 is additionally provided at a position closer to the nozzle 24 than the on-off valve 30 in the vertical direction.

In the present embodiment, accommodation recesses 65 for housing auxiliary valve piezoelectric elements 64a and 64b respectively, which constitute the auxiliary on-off valve 62, are formed next to the nozzle communication hole 34 of the communication plate 19. The opening of the accommodation recess 65 adjoining the nozzle communication hole 34 is hermetically closed by a third diaphragm 63, which has a structure similar to the structure of the first diaphragm 27 and the second diaphragm 40 described above. The auxiliary valve piezoelectric element 64a, 64b is formed on the surface of the third diaphragm 63 toward the accommodation recess 65. The auxiliary valve piezoelectric element 64a, 64b is a flexural-mode piezoelectric element that has a layered structure produced by sequentially forming a lower electrode layer, a piezoelectric layer, and an upper electrode layer, none of which is illustrated, and deforms when a valve-opening/closing drive signal is applied, similarly to the on-off valve piezoelectric element 38a, 38b described above.

In usual operation status such as during printing, the on-off valve 30 is closed to produce a non-communication state as illustrated in FIG. 8 because of continuous application of a valve-closing voltage having a certain level to each of the on-off valve piezoelectric elements 38a and 38b constituting the on-off valve 30, whereas the auxiliary valve piezoelectric elements 64a and 64b are flexibly separated from each other, meaning that the auxiliary on-off valve 62 is open, because of continuous application of a valve-opening voltage having a certain level to each of the auxiliary valve piezoelectric elements 64a and 64b constituting the auxiliary on-off valve 62. Therefore, the pressure compartment 25 is in communication with the nozzle 24 through the nozzle communication hole 34, whereas the individual flow passage leading from the pressure compartment 25 to the nozzle 24 is not in communication with the common discharge passage 15. In this state, it is possible to eject ink from the nozzle 24 by driving the piezoelectric element 28.

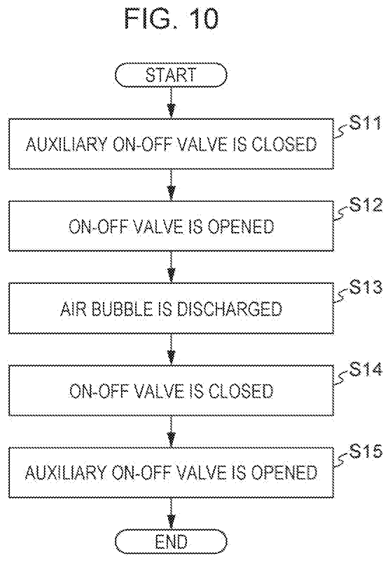

FIG. 10 is a flowchart for explaining air bubble discharging operation according to the second embodiment. In the present embodiment, when air bubble discharging operation is triggered by detection of ejection abnormality by the nozzle abnormality detector 60, first, a valve-closing voltage is applied to each of the auxiliary valve piezoelectric elements 64a and 64b constituting the auxiliary on-off valve 62; therefore, the auxiliary valve piezoelectric elements 64a and 64b deform toward, and become in contact with, each other, to close the auxiliary on-off valve 62 (first valve switching process: step S11). Next, a valve-opening voltage is applied to each of the on-off valve piezoelectric elements 38a and 38b constituting the on-off valve 30 to open the on-off valve 30 for communication (second valve switching process: step S12). Because of this operation, as illustrated in FIG. 9, air, that is, the air bubble B, is discharged together with a part of the ink in the individual flow passage to the common discharge passage 15 through the individual discharge passage 16 (air discharge process: step S13). Since the auxiliary on-off valve 62 is closed, the present embodiment prevents external air from being sucked into the individual flow passage through the nozzle 24 when negative pressure is applied to the common discharge passage 15. Therefore, it is possible to apply greater negative pressure to the common discharge passage 15 in the present embodiment than in the foregoing first embodiment. The greater negative pressure increases the possibility of successful discharging of the air (air bubble B) present inside the individual flow passage, without a significant risk of sucking external air into the individual flow passage through the nozzle 24 because of the valve closure. After the air bubble B is discharged to the common discharge passage 15, a valve-closing voltage is applied to each of the on-off valve piezoelectric elements 38a and 38b to close the on-off valve 30, meaning a non-communication state (third valve switching process: step S14). A valve-opening voltage having a certain level is applied to each of the auxiliary valve piezoelectric elements 64a and 64b constituting the auxiliary on-off valve 62 and, therefore, the auxiliary valve piezoelectric elements 64a and 64b change in shape flexibly to become separated from each other to open the auxiliary on-off valve (fourth valve switching process: step S15). In the present embodiment, the first valve switching process (S11) and the second valve switching process (S12) may be executed concurrently. Similarly, the third valve switching process (S14) and the fourth valve switching process (S15) may be executed concurrently. In that case, it is advantageous to delay reducing the pressure of the common discharge passage 15 by the pump 9 until the valve switching processes end, or weaken the reduction, so as to avoid external air from being sucked into the individual flow passage through the nozzle 24. Except for the difference described above, the structure is the same as that of the first embodiment.

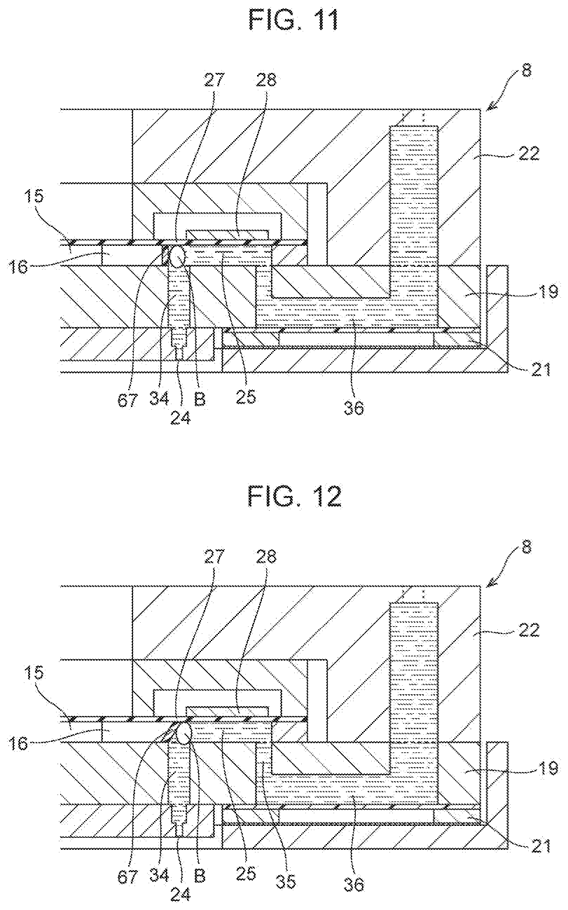

FIG. 11 is a cross-sectional enlarged view of a part of the recording head 8 according to a third embodiment of the present disclosure. In the present embodiment, the on-off valve 30 of the first embodiment is replaced with a gas permeable film 67 (a kind of gas permeable member according to the present disclosure, a kind of partitioning member according to the present disclosure) that is more permeable to a gaseous body (air) than to liquid such as ink. In this respect, the present embodiment is different from the foregoing embodiments. Accordingly, in the present embodiment, the gas permeable film 67, the individual discharge passage 16, and the common discharge passage 15 behave as an example of an air discharge mechanism according to the present disclosure. For example, a waterproof but moisture-permeable material such as Gore-Tex (®) or a polymeric membrane that has high gas/air permeability (for example, poly[1-(trimethylsilyl)-1-propyne]) may be used as the material of the gas permeable film 67. In this structure, since the gas permeable film 67 allows air, that is, an air bubble, to pass but does not allow ink to pass, the space of the individual discharge passage 16 and the common discharge passage 15 is not filled with ink. The pressure inside the common discharge passage 15 is reduced by a pressure reduction mechanism such as the pump 9. Therefore, the air bubble B present inside the individual flow passage passes through the gas permeable film 67 gradually, then moves into the common discharge passage 15 through the individual discharge passage 16 and is finally discharged to the outside of the recording head 8. The present embodiment makes it possible to remove the air bubble B present inside the individual flow passage by means of a simpler structure than that of the foregoing first and second embodiments. Moreover, by keeping the pressure of the common discharge passage 15 reduced while the power of the printer 1 is ON, it is possible to remove an air bubble from the ink in the individual flow passage before it grows larger. This makes it possible to more effectively prevent ink-ejection problems caused by an air bubble. The discharge passage, that is, the individual discharge passage 16 and the common discharge passage 15 in the exemplary embodiments, does not necessarily have to be reduced in pressure. For example, the discharge passage may be open to air. In this case, the air bubble B present inside the individual flow passage is able to move into the common discharge passage 15 through the gas permeable film 67 when ink pressure inside the pressure compartment 25 becomes higher than atmospheric pressure during operation for ejecting ink from the nozzle 24.

FIG. 12 is a cross-sectional enlarged view of a part of the recording head 8 according to a variation example of a third embodiment of the present disclosure. The illustrated variation example has a feature that the gas permeable film 67 is inclined with respect to the upper and lower surfaces of the pressure compartment substrate 26. More specifically, the gas permeable film 67 is inclined such that, the closer to the ceiling from the floor of the pressure compartment 25, the closer to the individual communication hole 35 and the pressure compartment 25. Since the gas permeable film 67 is inclined as described above, a part of the gas permeable film 67 overlaps with the nozzle communication hole 34 as viewed in the vertical direction. The inclination makes it easier for the air bubble B to come into contact with the overlapping part due to buoyancy. This makes it easier to discharge the air bubble (i.e., air) through the gas permeable film 67. Except for the difference described above, the structure is the same as that of the third embodiment.

Besides those described above, the technique of the present disclosure may be applied to a liquid ejecting head that has a flow passage leading from a pressure compartment to a nozzle and ejects liquid from the nozzle by driving of a drive element, and a liquid ejecting apparatus equipped therewith. Application examples include, but not limited to: a color material ejecting head used for manufacturing a color filter for a liquid crystal display, etc., an electrode material ejecting head used for forming electrodes of an organic EL (electroluminescence) display or an FED (surface/plane emission display), etc., a living organic material ejecting head used for producing biochips (biochemical element), a liquid ejecting head including a plurality of such a variety of heads, and a liquid ejecting apparatus equipped therewith.

What is claimed is:

1. A liquid ejecting head, comprising:
a nozzle from which liquid is ejected;
a pressure compartment that is in communication with the nozzle;
a flow passage configured to lead the liquid between the nozzle and pressure compartment; and
an air discharge mechanism configured to discharge air to outside from inside of the flow passage.

2. The liquid ejecting head according to claim 1, wherein
the pressure compartment is located above the nozzle in a vertical direction, and
the air discharge mechanism is provided closer to the pressure compartment than the nozzle in the vertical direction.

3. The liquid ejecting head according to claim 1, wherein
the air discharge mechanism includes a discharge passage, through which the air is discharged from the flow passage, and a partitioning member serving as a partition between the flow passage and the discharge passage.

4. The liquid ejecting head according to claim 3, further comprising:
a pressure reduction mechanism configured to reduce pressure inside the discharge passage.

5. The liquid ejecting head according to claim 3, wherein
the partitioning member is a gas permeable member that is more permeable to the air than to the liquid.

6. The liquid ejecting head according to claim 3, wherein
the partitioning member is an on-off valve configured to switch between a communication state, in which the flow passage is in communication with the discharge passage, and a non-communication state, in which the flow passage is not in communication with the discharge passage.

7. The liquid ejecting head according to claim 6, further comprising:
an auxiliary on-off valve provided closer to the nozzle than the air discharge mechanism in the vertical direction and configured to switch between an open state of allowing the liquid to pass in the flow passage and a closed state of not allowing the liquid to pass in the flow passage.

8. A liquid ejecting apparatus, comprising:
the liquid ejecting head according to claim 1.

9. A liquid ejecting apparatus, comprising:
the liquid ejecting head according to claim 2.

10. A liquid ejecting apparatus, comprising:
the liquid ejecting head according to claim 3.

11. A liquid ejecting apparatus, comprising:
the liquid ejecting head according to claim 4.

12. A liquid ejecting apparatus, comprising:
the liquid ejecting head according to claim 5.

13. A liquid ejecting apparatus, comprising:
the liquid ejecting head according to claim 6.

14. A liquid ejecting apparatus, comprising:
the liquid ejecting head according to claim 7.

15. A method for controlling a liquid ejecting head comprising:
a nozzle from which liquid is ejected;
a pressure compartment that is in communication with the nozzle;
a flow passage configured to lead the liquid between the nozzle and pressure compartment;
an air discharge mechanism configured to discharge air to outside from inside of the flow passage, the air discharge mechanism including
a discharge passage, through which the air is discharged from the flow passage,
an on-off valve provided between the flow passage and the discharge passage; and
an auxiliary on-off valve provided closer to the nozzle than the air discharge mechanism in the vertical direction, the method comprising:
switching by the auxiliary on-off valve from an open state of allowing the liquid to pass in the flow passage to a closed state of not allowing the liquid to pass in the flow passage;
switching by the on-off valve from a non-communication state, in which the flow passage is not in communication with the discharge passage to a communication state, in which the flow passage is in communication with the discharge passage, in accordance with switching by the auxiliary on-off valve from the open state to the closed state;
discharging the air from the flow passage toward the discharge passage;
switching by the on-off valve from the communication state to the non-communication state after the air is discharged; and
switching by the auxiliary on-off valve from the closed state to the open state in accordance with switching by the on-off valve from the communication state to the non-communication state.
